(19) United States
(12) Patent Application Publication
(10) Pub. No.: US 2002/0171538 A1
(43) Pub. Date: Nov. 21, 2002

(54) Vehicle motion detector and control device arrangement

(76) Inventors: Kuo-Hsin Su, Hsintien City (TW); Paul Huang, Foster City, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/854,565

(22) Filed: May 15, 2001

(51) Int. Cl. B60Q 1/00

(52) U.S. Cl. 340/441; 340/427; 340/426; 340/679; 70/239; 180/281

(57) ABSTRACT

A vehicle motion detector and control device arrangement includes a casing, a rotor rotated with the transmission line of the cable of the mileage meter of the motor vehicle in the casing, a rotary driven member revolvably supported on a damping oil in an annular end chamber of the rotary member and maintained in the middle position by magnetic expulsive force, and switch means mounted outside the casing and induced by a magnet at the rotary driven member to turn on a control device of the motor vehicle upon operation of the motor vehicle.

### BACKGROUND OF THE INVENTION

The present invention relates to a vehicle motion detector and control device arrangement, which comprises a vehicle motion detector that detects the motion of the motor vehicle, and a control device controlled to work by the vehicle motion detector.

The central lock system of a car is controlled to lock/unlock the lock by means of the induction of the revolving speed of the engine. If the driver gets off the car to clean the windshield after the car has been started, the central lock system may be induced to lock the lock automatically, causing the driver unable to enter the car. It is dangerous when a young child is staying inside the car at this time. Further, when unlocked manually, the central lock system cannot automatically lock the lock.

Regular motorcycles are commonly equipped with a motorcycle stand. The motorcycle stand is moved between the operative position and the non-operative position with the leg. If the rider of a motorcycle forgot to lift the motorcycle stand from the operative position to the non-operative position before riding the motorcycle, the protruding motorcycle stand may hit an external object during running of the motorcycle, causing the motorcycle and the rider to fall to the ground. Further, when parking a motorcycle in a narrow space, it is difficult to lower the motorcycle stand from the non-operative position to the operative position with the leg.

### SUMMARY OF THE INVENTION

The present invention has been accomplished under the circumstances in view. According to one aspect of the present invention, the vehicle motion detector and control device arrangement includes a casing, a rotor rotated with the transmission line of the cable of the mileage meter of the motor vehicle in the casing, a rotary driven member revolvably supported on a damping oil in an annular end chamber of the rotary member and maintained in the middle position by magnetic expulsive force, and switch means mounted outside the casing and induced by a magnet at the rotary driven member to turn on a control device of the motor vehicle upon operation of the motor vehicle. According to another aspect of the present invention, the switch means can be a solenoid switch, or an optical transmitter and receiver unit. In one application example of the present invention, the control device is a control circuit that controls the lock of the central lock system of the car in which the vehicle motion detector is installed. In another application example of the present invention, the vehicle motion detector is installed in a motorcycle to control the operation of a motor that is driven to move the motorcycle stand of the motorcycle between the operative position and the non-operative position.

### BRIEF DESCRIPTION OF THE DRAWINGS

FIG. 1 is an exploded view of a vehicle motion detector according to the present invention.

FIG. 2 is a sectional assembly view of the vehicle motion detector according to the present invention.

FIG. 3 is a cross sectional view of FIG. 2.

FIG. 4 is another sectional view of the vehicle motion detector according to the present invention.

FIG. 5 shows the vehicle motion detector installed in a motorcycle and connected to the cable of the mileage meter.

FIG. 6 is an exploded view of a motorcycle stand control device according to the present invention.

FIG. 6-1 is a perspective assembly view of FIG. 6.

FIG. 6-2 is a side plain view in an enlarged scale of the motorcycle stand control device according to the present invention.

FIG. 6-3 is another side plain view of the motorcycle stand control device according to the present invention.

FIG. 7 illustrates the vehicle motion detector installed in a car and connected to the control circuit of the control lock control system of the car.

FIG. 8 is a sectional view of an alternate form of the vehicle motion detector according to the present invention.

FIG. 9 illustrates the vehicle motion detector installed in the cable of a mileage meter.

FIG. 10 shows another installation example of the vehicle motion detector in the mileage meter of a motor vehicle.

### DETAILED DESCRIPTION OF THE PREFERRED EMBODIMENT

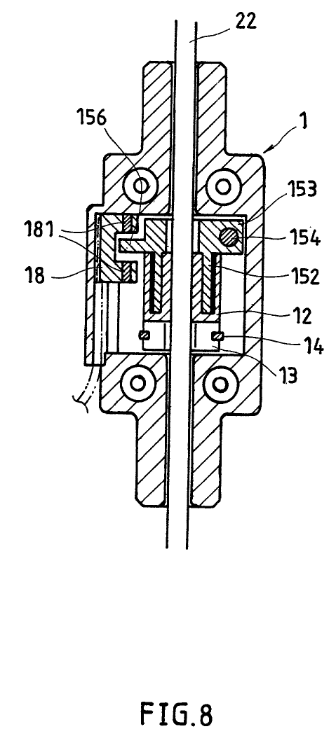

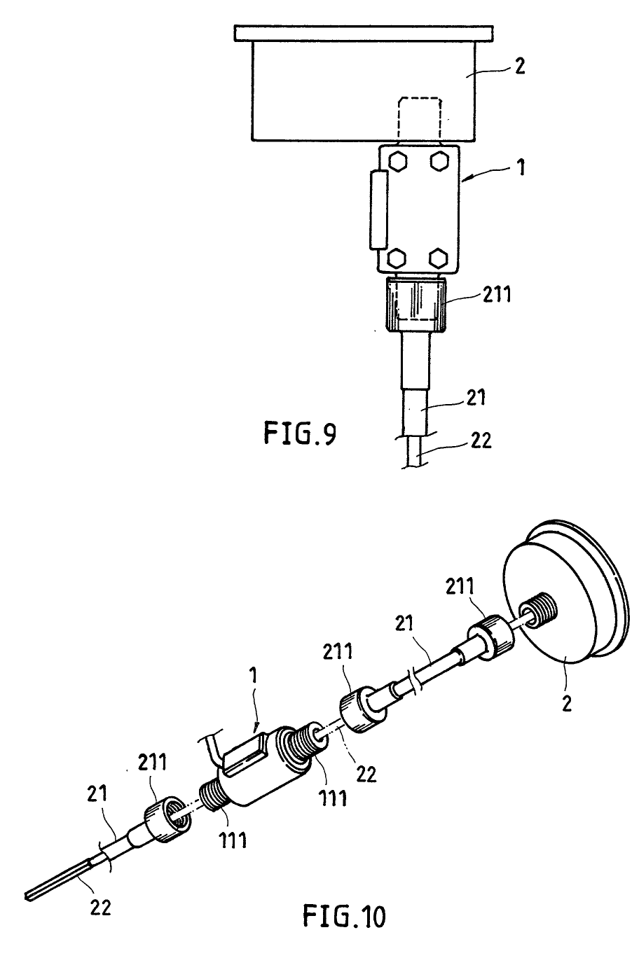

Referring to FIGS. from 1 through 4, a vehicle motion detector 1 is shown comprised of a casing 11, a rotor 12, a rotary driven member 15, and a circuit board 16. The casing 11 is formed of two symmetrical half shells fixedly fastened together by screw bolts 114, comprising two threaded necks 111 at two distal ends onto which two screw caps 211 are respectively threaded to secure two sleeves 21 to the casing 11, enabling the transmission line 22 of the cable of the vehicle mileage meter 2 to be inserted through the sleeves 21 and the casing 11 (see also FIGS. 9 and 10). The rotor 12 is mounted in the casing 11, comprising an axial hole 121, an annular end chamber 122 disposed at one end thereof around the axial hole 121 and filled up with a damping oil 17 and adapted to receive the rotary driven member 15. The rotary driven member 15 comprises a tubular body 152 inserted into the annular end chamber 122 of the rotor 12 and defining an axial hole 151 in axial alignment with the axial hole 121 of the rotor 12, and a lug 153 extended from the periphery of the upper end of the tubular body 152 and fixedly mounted with a magnet 154. The casing 11 further comprises two radial holes 112 at two sides, and two magnets 113 respectively aimed at two opposite ends of the magnet 154 in the lug 153. The polarity of the magnets 113 are reversed to the polarity of the two opposite ends of the magnet 154 in the lug 153. The transmission line 22 of the cable of the mileage meter 2 is inserted through the axial hole 151 of the rotary driven member 15 and the axial hole 121 of the rotor 12. Two clamping plates 13 are respectively mounted in positioning notches 124 at the bottom side of the rotor 12 to hold the transmission line 22. The clamping plates 13 each have a bearing portion 131 of smoothly arched cross section adapted to support the transmission line 22. A C-shaped clamp 14 is fastened to an outside annular groove 123 around the periphery of the rotor 12 to fixedly secure the clamping plates 13, the transmission line 22 and the rotor 12 together. During running of the vehicle, the rotor 12 is rotated with the transmission line 22 of the cable of the mileage meter 2 (see also FIGS. 9 and 10), and the rotary driven member 15 is forced by the damping oil 17 to rotate in one direction until the lug 153 had been stopped at one end of one radial hole 112 of the casing 11. At this time, the transmission line 22 is continuously rotated to stir up the damping oil 17, thereby keeping the rotary driven member 15 in the biased position (where the lug 153 is stopped at one end of one radial hole 112 of the casing 11). The rotary driven member 15 further comprises two magnets 155 and 1551 disposed at the periphery at different locations. The circuit board 16 is disposed at one side of the casing 11, comprising a solenoid 161 adapted to act with the magnet 155 or 1551. The solenoid 161 has two opposite terminals respectively connected to a control device of the vehicle by electric wires 162. When the rotary driven member 15 biased in one direction during forward movement of the vehicle, one magnet 155 is moved with the rotary driven member 15 toward the solenoid 161, thereby causing the solenoid 161 to be electrically connected to turn on the control device of the vehicle. When the vehicle biased in the reversed direction during backward movement of the vehicle, the other magnet 1551 is moved with the rotary driven member 15 toward the solenoid 161, and the solenoid 161 is maintained electrically connected.

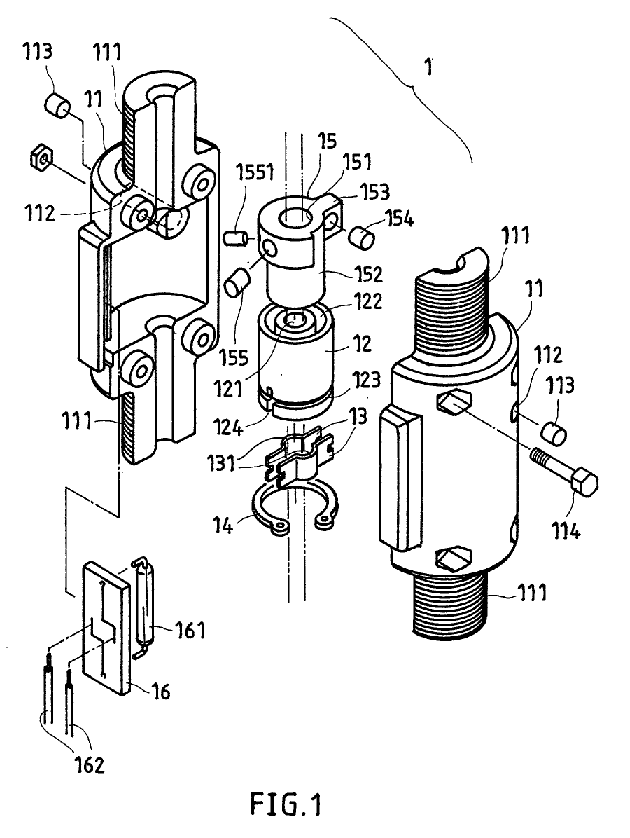

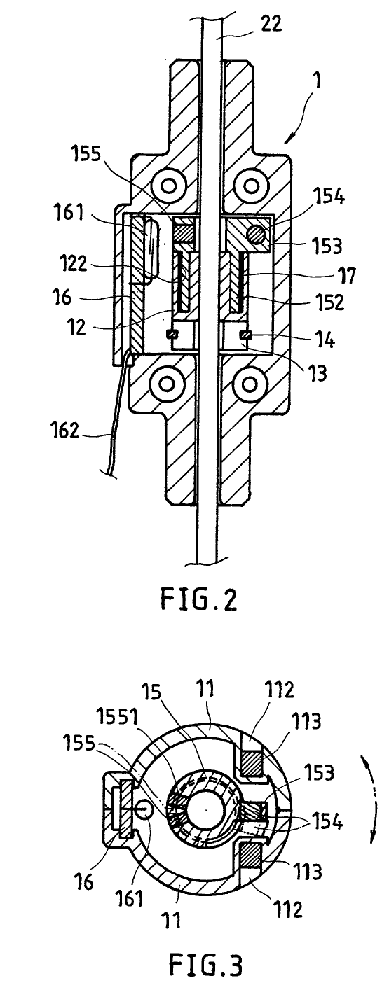

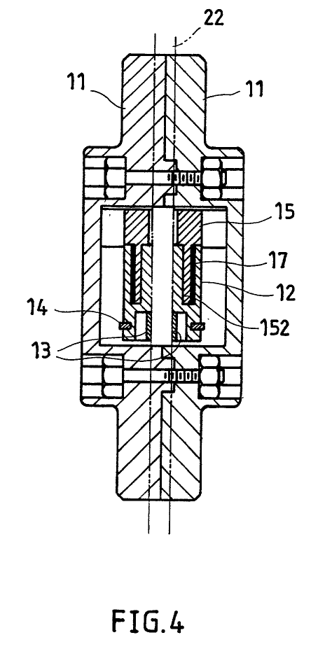

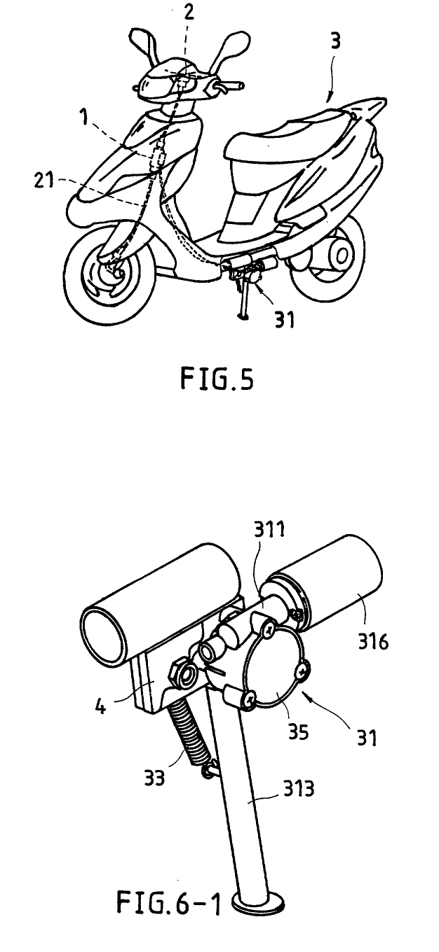

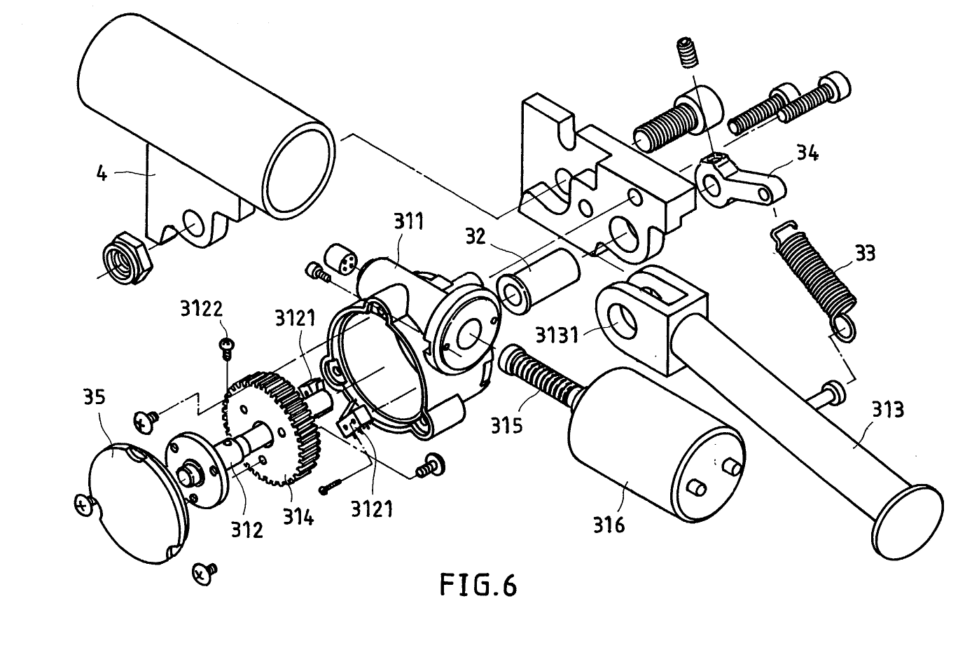

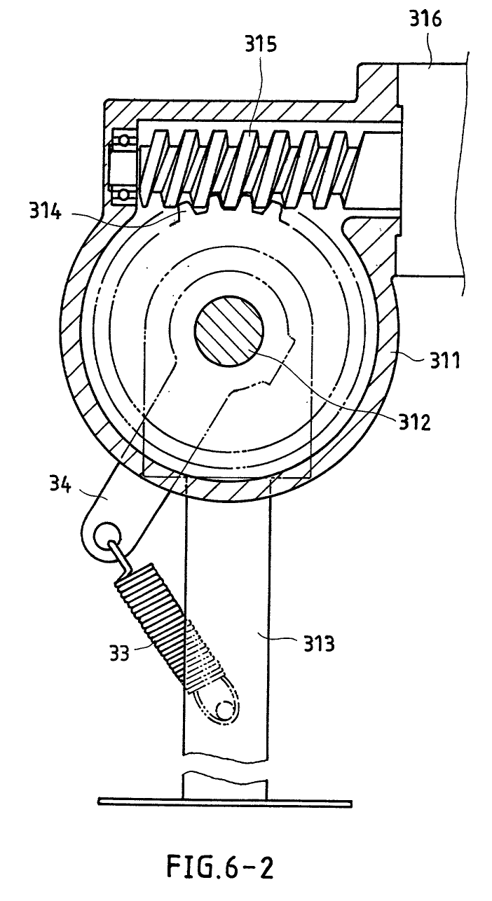

Referring to FIGS. 5, 6, 6-1, 6-2, and 6-3, the vehicle motion detector 1 can be used to control the motorcycle stand 31 of a motorcycle 3. The motorcycle 3 comprises a bracket 4 adapted to support a holder 311. The holder 311 holds a motor 316. The motor 316 has a gear 315 fixedly mounted on the output shaft thereof. An axle 312 is inserted through the holder 311, having one end revolvably supported on an axle bearing (not shown) at a cap 35 at one side of the holder 311. A gear 314 is mounted on the axle 312 and meshed with the gear 315 at the output shaft of the motor 316. An actuating screw 3122 is fixedly fastened to the axle 312. Two limit switches 3121 are mounted in the holder 311 and spaced from the actuating screw 3122 at two sides. When starting the engine of the motorcycle 3, the transmission line 22 is rotated to trigger the vehicle motion detector 1, causing the vehicle motion detector 1 to turn on the motor 316. When starting the motor 316, the actuating screw 3122 is turned with the axle 312 to touch one limit switch 3121, thereby causing the motorcycle stand 313 to be lifted from the operative position to the non-operative position. An arm 34 is provided having one end fixedly fastened to one end of the axle 312 and an opposite end connected to a side rod on the middle of the motorcycle stand 313 through a tensile spring 33. When stopping the motorcycle 3, the circuit board 16 of the vehicle motion detector 1 starts the motor 316 to turn the axle 312 in one direction, thereby causing the arm 34 to be rotated with the axle 312 to pull the motorcycle stand 313 from the non-operative position to the operative position to support the motorcycle 3 on the ground. After the motorcycle stand 313 has been lowered from the non-operative position to the operative position, the actuating screw 3122 triggers the other limit switch 3121 to cut off power supply from the motor 316. Further, a bushing 32 is sleeved onto the axle 312 and mounted in a pivot hole 3131 at one end of the motorcycle stand 313, for enabling the motorcycle stand 313 to be turned about the bushing 32 between the operative position and the non-operative position.

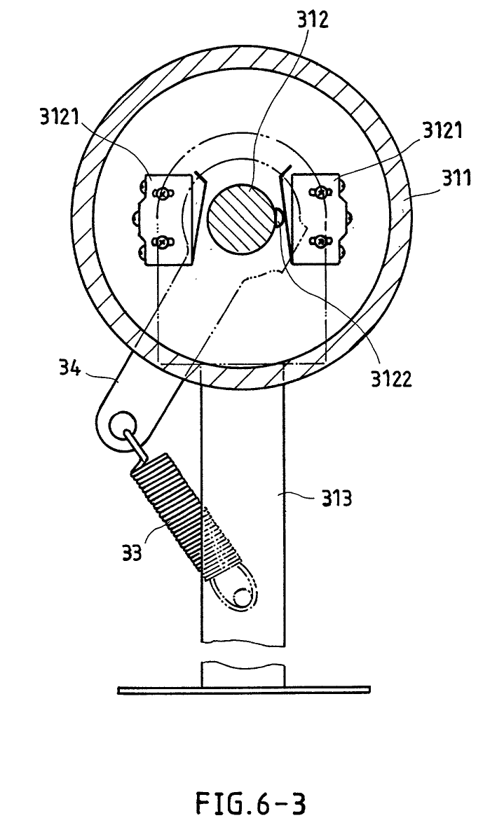

FIG. 7 shows the vehicle motion detector 1 used in a car to control the central lock 164. When starting the car, the solenoid of the vehicle motion detector 1 is electrically connected to give a signal to the central lock control circuit 163 through the electric wires 162, thereby causing the central lock control circuit 163 to unlock the central lock 164.

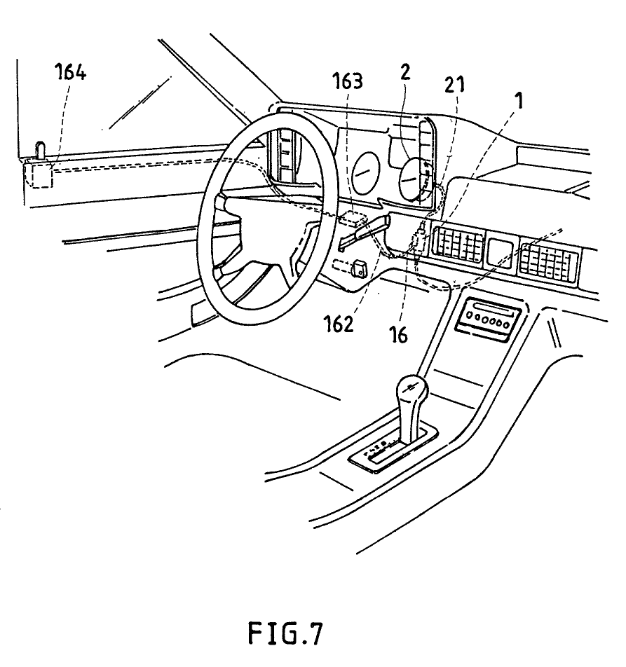

FIG. 8 shows an alternate form of the present invention. According to this embodiment, the circuit board 18 comprises an optical transmitter and receiver unit 181, and the rotary driven member 15 comprises a mask plate 156 at one side. The mask plate 156 is inserted in between the transmitter and receiver of the transmitter and receiver unit 181 of the circuit board 18 when starting the vehicle, thereby causing the circuit board 18 to turn on the control device of the vehicle.

A prototype of vehicle motion detector has been constructed with the features of FIGS. 1˜10. The heat sink functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A vehicle motion detector and control device arrangement comprising:
a casing, said casing comprising two symmetrical half shells fastened together and secured to the sleeve of the cable of the mileage meter of a motor vehicle for enabling the transmission line of the cable of the mileage meter to pass axially through said casing, said casing comprising two radial holes disposed at two sides, and two magnets respectively mounted in said radial holes;
a rotor mounted in said casing and rotated with the transmission line of the cable of the mileage meter of the motor vehicle upon starting of the motor vehicle, said rotor comprising an axial through hole, which receives the transmission line of the cable of the mileage meter of the motor vehicle, an annular chamber at a top end thereof around the axial through hole of said rotor, and a damping oil filled in said annular chamber;
a rotary driven member suspending in said casing, said rotary driven member comprising a tubular body disposed around the transmission line of the cable of the mileage cable of the motor vehicle, a lug extended from the periphery of an upper end of said tubular body, a first magnet fixedly mounted in said lug and aimed between the magnets of said casing, said first magnet having the polarity of the two distal ends of said first magnet being reversed to the polarity of the magnets of said casing, a second magnet mounted in the periphery of said tubular body, and a third magnet mounted in the periphery of said tubular body;
a circuit board mounted on said casing at one side, said circuit board comprising switch means; and
a control device controlled to work by said switch means of said circuit board;
wherein the first magnet of said rotary driven member is forced by the magnets of said casing to keep said rotary driven member in a middle position where the second and third magnets of said rotary driven member are equally spaced from the switch means of said circuit board and the switch means of said circuit board is off when the motor vehicle is turned off; one of the second and third magnets of said rotary driven member is moved with said rotary driven member to induce the switch means of said circuit board when the motor vehicle is started and moved forwards or backwards, causing said switch means to turn on said control device.

2. The vehicle motion detector and control device arrangement of claim 1 wherein said switch means of said circuit board is a solenoid switch.

3. The vehicle motion detector and control device arrangement of claim 1 wherein said switch means comprises an optical transmitter and receiver unit formed of an optical transmitter and an optical receiver, and said rotary driven member comprises a mask plate, which is moved into said optical transmitter and receiver unit to switch on said switch means upon operation of the motor vehicle.

4. The vehicle motion detector and control device arrangement of claim 1 wherein said control device is a control circuit that controls the operation of the central lock of the motor vehicle.

5. The vehicle motion detector and control device arrangement of claim 1 wherein said control device is controlled by said switch means of said circuit board to move a motorcycle stand between the operative position and the non-operative position, said control device comprising a bracket fixedly fastened to the frame of the motor vehicle, a holder mounted on said bracket, a motor mounted on said holder and electrically connected to said switch means of said circuit board, an axle mounted in said holder, a drive gear driven by said motor, a driven gear fixedly mounted on said axle and meshed with said drive gear for enabling said axle to be rotated upon operation of said motor, an arm, said arm having one end fixedly fastened to one end of said axle and an opposite end connected to a part of said motorcycle stand by a tensile spring, a mounted on said axle and coupled to one end of said motorcycle stand for enabling said motorcycle stand to be turned about said bushing between the operative position and the non-operative position, two limit switches mounted in said holder and adapted to control the operation of said motor, and an actuating screw fixedly mounted on said axle and turned with said axle to touch said limit switches.
